(19) United States
(12) Patent Application Publication
(10) Pub. No.: US 2024/0079746 A1
(43) Pub. Date: Mar. 7, 2024

(54) TRACTION BATTERY PACK TERMINAL BACKER AND SENSE LEAD

(71) Applicant: Ford Global Technologies, LLC, Dearborn, MI (US)

(72) Inventors: Brock Dunlap, Dearborn, MI (US); Deanna Marie Winton Hoffman, Ann Arbor, MI (US); Marc Dugas, Wixom, MI (US)

(21) Appl. No.: 18/176,572

(22) Filed: Mar. 1, 2023

Related U.S. Application Data
(60) Provisional application No. 63/403,445, filed on Sep. 2, 2022.

(51) Int. Cl. H01M 50/566; H01M 10/0525; H01M 50/538

(52) U.S. Cl. CPC H01M 50/566; H01M 10/0525; H01M 50/538; H01M 2220/20

(57) ABSTRACT

A battery pack terminal retention system includes a sense lead, and a plurality of tab terminals secured directly to each other and to the sense lead. A battery pack terminal retention method includes securing a plurality of tab terminals to a sense lead; and monitoring a voltage using the sense lead. The tab terminals can be secured to the sense lead via welds.

### CROSS-REFERENCE TO RELATED APPLICATIONS

This application claims priority to U.S. Provisional Application No. 63/403,445, which was filed on 2 Sep. 2022 and is incorporated herein by reference.

### TECHNICAL FIELD

This disclosure relates generally to securing terminals of battery cells to within a traction battery pack to a sense lead.

### BACKGROUND

A traction battery pack of an electrified vehicle can include groups of battery cells arranged in one or more cell stacks. The battery cells can include terminals, which are typically electrically connected to other terminals, a busbar, or both.

### SUMMARY

In some aspects, the techniques described herein relate to a battery pack terminal retention system, including: a sense lead; and a plurality of tab terminals secured directly to each other and to the sense lead.

In some aspects, the techniques described herein relate to a battery pack terminal retention system, further including a cross-member, the sense lead secured to the cross-member.

In some aspects, the techniques described herein relate to a battery pack terminal retention system, further including at least one heat stake securing the sense lead to the cross-members.

In some aspects, the techniques described herein relate to a battery pack terminal retention system, wherein the tab terminals extend through an aperture in the cross-member when the plurality of tab terminals are secured to directly to the sense lead.

In some aspects, the techniques described herein relate to a battery pack terminal retention system, wherein the cross-member is a composite material.

In some aspects, the techniques described herein relate to a battery pack terminal retention system, further including a plurality of welds that secure the plurality of tab terminals directly to the sense lead.

In some aspects, the techniques described herein relate to a battery pack terminal retention system, wherein the plurality of tab terminals extend from a plurality of lithium-ion battery cells.

In some aspects, the techniques described herein relate to a battery pack terminal retention system, further including a jumper operably coupling the sense lead to a module of a battery pack.

In some aspects, the techniques described herein relate to a battery pack terminal retention system, wherein the tab terminals have a first height and the sense lead has a second height that is greater than the first height.

In some aspects, the techniques described herein relate to a battery pack terminal retention system, wherein the plurality of tabs includes at least one first tab folded over the sense lead in a first direction and at least one second tab folded over the sense lead in a second direction that is opposite the first direction.

In some aspects, the techniques described herein relate to a battery pack terminal retention system, wherein the sense lead includes first area and a second area that is separate from the first area, wherein the plurality of tabs includes at least one first tab welded directly to a first area of the sense lead, and at least one second tab welded directly to the second area.

In some aspects, the techniques described herein relate to a battery pack terminal retention system, wherein the first tab is detached from the second area, and the second tab is detached from the first area.

In some aspects, the techniques described herein relate to a battery pack terminal retention system, further including a plurality of welds that electrically connect together the plurality of tab terminals.

In some aspects, the techniques described herein relate to a battery pack terminal retention system, wherein the plurality of tab terminals includes at least two tab terminals.

In some aspects, the techniques described herein relate to a battery pack terminal retention method: securing a plurality of tab terminals to a sense lead; and monitoring a voltage using the sense lead.

In some aspects, the techniques described herein relate to a battery pack terminal retention method further including securing the tab terminals to the sense lead using a plurality of welds.

In some aspects, the techniques described herein relate to a battery pack terminal retention method, further including folding the plurality of tab terminals over the sense lead prior to the securing.

In some aspects, the techniques described herein relate to a battery pack terminal retention method, wherein the plurality of tab terminals extend from a plurality of lithium-ion battery cells.

In some aspects, the techniques described herein relate to a battery pack terminal retention method, further including securing at least one first terminal within the plurality of terminals to a first area of the sense lead, and securing at least one second terminal within the plurality of terminals to a second area of the sense lead, the first and second areas separate and distinct from each other.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 2 according to an exemplary embodiment of the present disclosure.

FIG. 3 illustrates a perspective view of a portion of the battery pack of FIG. 2 with the enclosure assembled and with areas cut away to show an outboard region of a cross-member.

FIG. 4 illustrates a perspective view of a battery cell from the battery pack of FIG. 2.

FIG. 5 illustrates a top view of selected portions of a group of battery cells from the battery pack of FIG. 2.

FIG. 6 illustrates a close-up view of an area of FIG. 3 showing terminals of battery cells secured directly to a sense lead.

FIG. 7 illustrates a section view taken at line 7-7 in FIG. 6.

FIGS. 8A-8C illustrate selected steps in a method of securing the terminals within the battery pack of FIG. 2 to the sense lead

### DETAILED DESCRIPTION

This disclosure details exemplary battery terminal retention systems within a traction battery pack. The systems secure the terminals to a sense lead, which can, among other things, reduce overall system complexity.

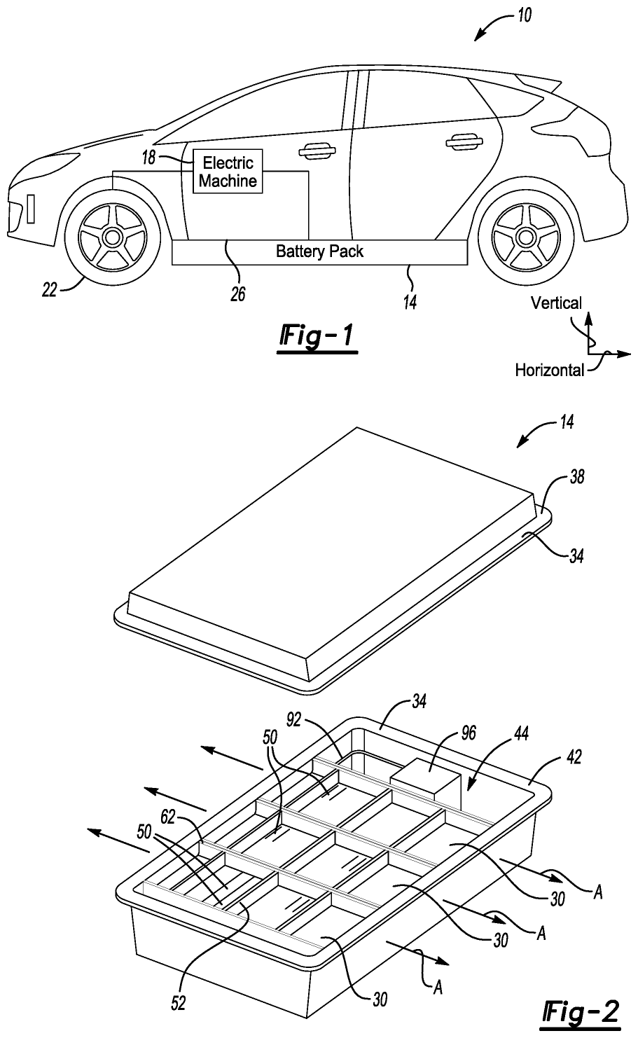

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

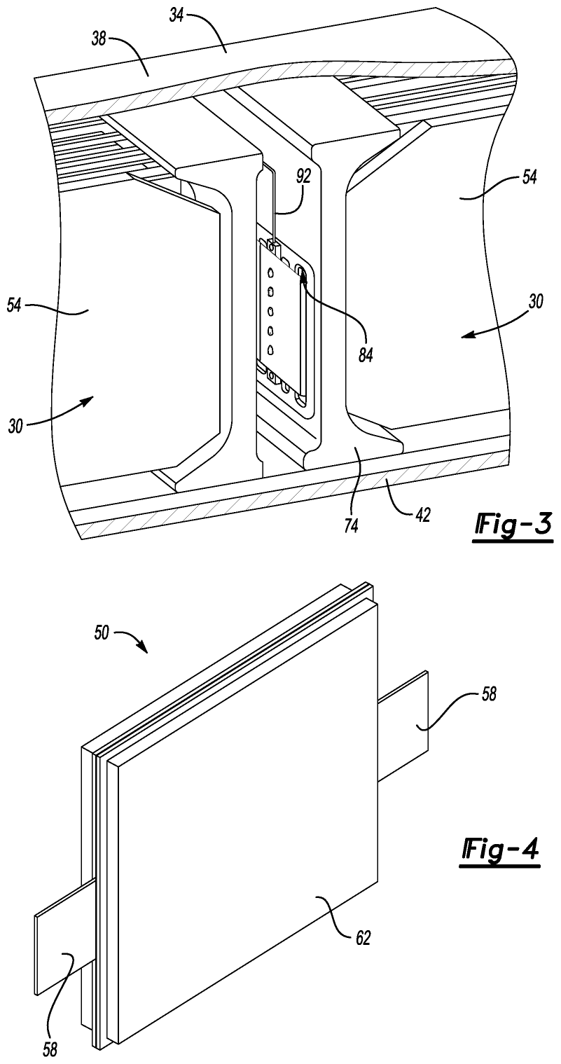

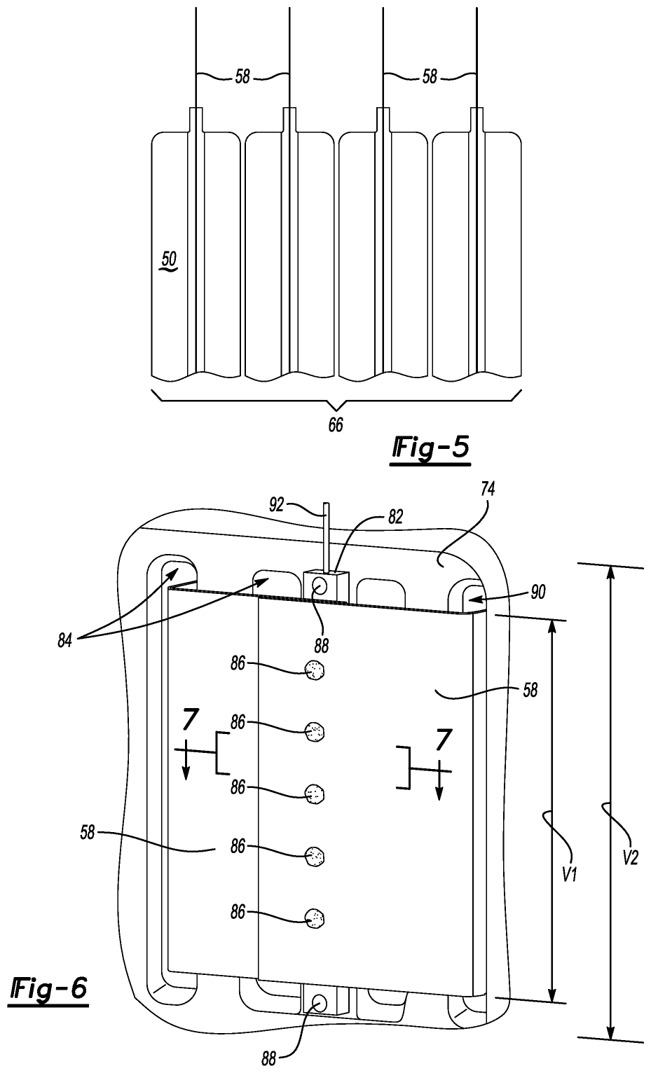

With reference now to FIGS. 2-7, the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes a plurality of battery cells 50 (or simply “cells”) and at least one divider 52 distributed along a respective cell stack axis A. The battery cells 50 are stacked side-by-side relative to each other along the cell stack axis A. Plates 54 can be positioned at opposing ends of the cell stacks 30.

The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch cells. However, battery cells having other geometries (cylindrical, prismatic, etc.), other chemistries (nickel metal hydride, lead acid, etc.), or both could be alternatively utilized within the scope of this disclosure. The exemplary battery cells 50 include tab terminals 58 extending from a battery cell housing 62. An aluminum film can provide at least part of the housing 62, for example. The housing 62 could additionally include a polymer. For each example battery cell 50, one of the terminals 58 is copper and the other is aluminum.

The battery pack 14 includes a plurality of cross-members 74 that are configured to transfer a load applied to a side of the vehicle 10, for example. The cross-members 74 are disposed between the cell stacks 30. In this example, the cross-members 74 extend longitudinally in a cross-vehicle direction. The cross-members 74 enhance the structural integrity of the battery pack 14.

The cross-members 74 are composite in this example. The cross-members 74 can primarily incorporate a polymer-based material.

With the cell stacks 30, the tab terminals 58 of different battery cells 50 can be electrically connected together. In this example, terminals 58 from groups 66 of four battery cells 50 (FIG. 6) are, when installed within the battery pack 14, electrically connected to each other and to one of a plurality of sense leads 82 within the battery pack.

The example sense leads 82 are mounted to the cross-members 74. The sense leads 82 can be distributed along different areas of the cross-members 74. In this example, the terminals 58 extend through apertures 84 in the cross-members 74 to connect to the sense leads 82.

The sense leads 82 are used to monitor various conditions within the battery pack 14. Distributing the sense leads 82 through different areas of the battery pack facilitates monitoring conditions in different areas of the battery pack 14.

The cell stacks 30 each include several groups of battery cells 50 like the group 66. The tab terminals 58 for the battery cells 50 in each group are secured to each other and to one of the sense leads 82.

In this example, welds 86 secure the tab terminals 58 to each other and to the sense lead 82. The welds 86 are laser welds in this example, but other types joining techniques could be used, including other types of welds, soldering, or clamping. The example sense leads 82 are a metal or metal alloy. The sense leads 82 provide backers for welding.

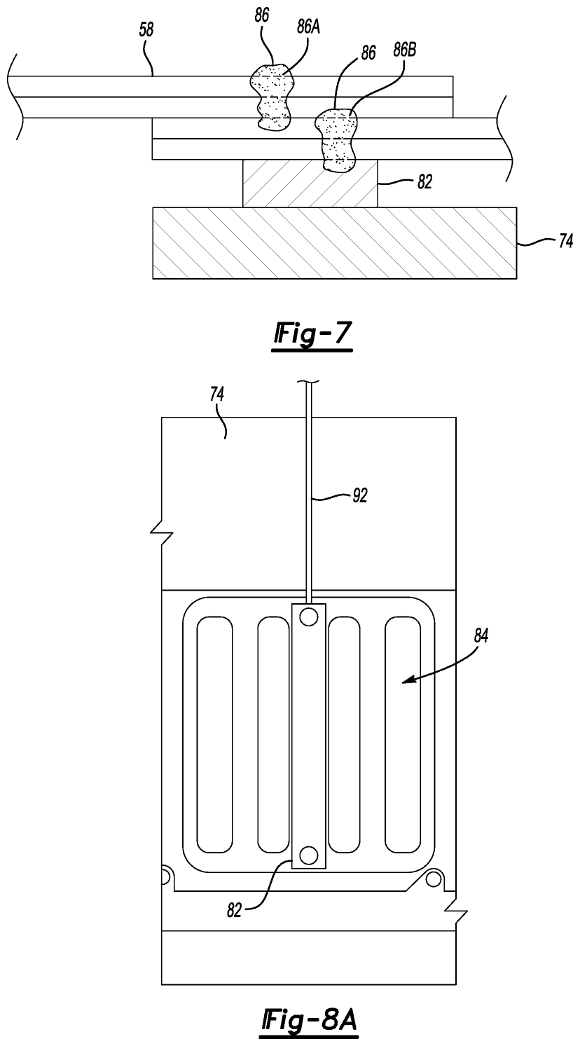

As shown in FIG. 7, the welds 86 need not extend through all the tab terminals 58 that are secured to one of the sense leads 82. In this example, one of the welds 86A secures together three of the tab terminals 58, and another of the welds 86B could secure those three tab terminals 58 to the remaining tab terminal 58 and the sense lead 82.

In some examples, a few of the tab terminals 58 are attached directly to a first area of the sense lead 82, and a few others of the tab terminals 58 are attached directly to a different, second area of the sense lead 82. The first area is separate from the second area. That is, the tab terminals 58 secured to the different areas may not overlap with each other. The tab terminals 58 that are attached directly to the first area are detached from all portions of the second area. The tab terminals 58 attached to the second area are detached from all portions of the first area.

Heat stakes 88 are used to secure the sense leads 82 to the cross-members 74 in this example. The sense leads 82 are secured to and supported by the cross-members 74 via the heat stakes 88. In other examples, attachments such as rivets, snap-fits, over-molds, adhesives, etc. could be used to secure the sense leads 82 to the cross-members 74.

The tab terminals 58 have a first height V1 and the sense leads 82 have a second height V2 that is greater than the first height. This allows the sense leads 82 to protrude vertically above and beneath the tab terminals 58. The heat stakes 88 are located in the protruding portions so that the tab terminals 58 can be welded to the sense lead 82 without interference from the heat stakes 88. Vertical, for purposes of this disclosure, is with reference to ground and a general orientation of the vehicle 10 during operation.

The sense lead 82, via a jumper 92, is operably coupled to a monitoring module 96. The jumper 92 can be secured to the sense lead via a spot weld, for example. The jumper 92 can instead or additionally be operably coupled to a module in-between the stacks 30, which is then connected to the module 96. The monitoring module 96 can include a printed circuit board.

The sense lead 82 and the jumper 92 provide a portion of a sensing circuit path that the monitoring module 96 uses to monitor various conditions, temperature, voltages, etc. The monitoring module 96 can monitor, for example, voltage at the sense lead 82 through the jumper 92. The sense lead 82 could be relied on to monitor conditions other than voltage. For example, the sense lead 82 could include a thermistor and help to sense temperature at the sense lead 82.

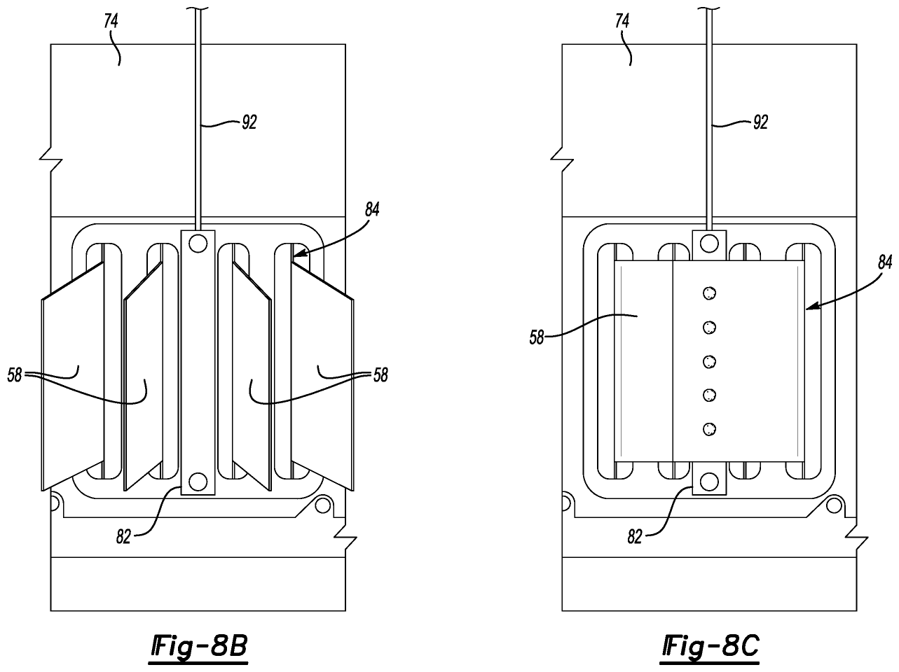

With reference now to FIGS. 8A to 8C, a method of securing the terminals 58 can be described as follows. The sense lead 82 is first mounted to the cross-member 74 adjacent to the apertures 84 as shown in FIG. 8A. The terminals 58 are then positioned within the apertures 84 in the cross-member 74 as shown in FIG. 8B. Next, the terminals 58 are folded over the sense lead 82 and then welded as shown in FIG. 8C. The welds 86 secure the terminals 58 directly to the sense lead 82. In some examples, a clasp or clip could be used to hold the terminals 58 in a folded position prior to welding.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack terminal retention system, comprising:
a sense lead; and
a plurality of tab terminals secured directly to each other and to the sense lead.

2. The battery pack terminal retention system of claim 1, further comprising a cross-member, the sense lead secured to the cross-member.

3. The battery pack terminal retention system of claim 2, further comprising at least one heat stake securing the sense lead to the cross-members.

4. The battery pack terminal retention system of claim 2, wherein the tab terminals extend through an aperture in the cross-member when the plurality of tab terminals are secured to directly to the sense lead.

5. The battery pack terminal retention system of claim 2, wherein the cross-member is a composite material.

6. The battery pack terminal retention system of claim 1, further comprising a plurality of welds that secure the plurality of tab terminals directly to the sense lead.

7. The battery pack terminal retention system of claim 1, wherein the plurality of tab terminals extend from a plurality of lithium-ion battery cells.

8. The battery pack terminal retention system of claim 1, further comprising a jumper operably coupling the sense lead to a module of a battery pack.

9. The battery pack terminal retention system of claim 1, wherein the tab terminals have a first height and the sense lead has a second height that is greater than the first height.

10. The battery pack terminal retention system of claim 1, wherein the plurality of tabs includes at least one first tab folded over the sense lead in a first direction and at least one second tab folded over the sense lead in a second direction that is opposite the first direction.

11. The battery pack terminal retention system of claim 1, wherein the sense lead includes first area and a second area that is separate from the first area, wherein the plurality of tabs includes at least one first tab welded directly to a first area of the sense lead, and at least one second tab welded directly to the second area.

12. The battery pack terminal retention system of claim 11, wherein the first tab is detached from the second area, and the second tab is detached form the first area.

13. The battery pack terminal retention system of claim 1, further comprising a plurality of welds that electrically connect together the plurality of tab terminals.

14. The battery pack terminal retention system of claim 1, wherein the plurality of tab terminals includes at least two tab terminals.

15. A battery pack terminal retention method:
securing a plurality of tab terminals to a sense lead; and
monitoring a voltage using the sense lead.

16. The battery pack terminal retention method of claim 15 further comprising securing the tab terminals to the sense lead using a plurality of welds.

17. The battery pack terminal retention method of claim 15, further comprising folding the plurality of tab terminals over the sense lead prior to the securing.

18. The battery pack terminal retention method of claim 15, wherein the plurality of tab terminals extend from a plurality of lithium-ion battery cells.

19. The battery pack terminal retention method of claim 15, further comprising securing at least one first terminal within the plurality of terminals to a first area of the sense lead, and securing at least one second terminal within the plurality of terminals to a second area of the sense lead, the first and second areas separate and distinct from each other.
